(19) United States
(12) Patent Application Publication
(10) Pub. No.: US 2026/0302054 A1
(43) Pub. Date: Oct. 1, 2026

(54) INDUCTOR

(71) Applicant: TDK Corporation, Tokyo (JP)

(72) Inventors: Takahiro NEMOTO, Tokyo (JP); Hokuto EDA, Tokyo (JP); Kohei TAKAHASHI, Tokyo (JP); Yuma USAMI, Tokyo (JP); Ryota ISHIKAWA, Tokyo (JP)

(73) Assignee: TDK Corporation, Tokyo (JP)

(21) Appl. No.: 19/632,657

(22) Filed: Mar. 30, 2026

(30) Foreign Application Priority Data
Mar. 31, 2025 (JP) 2025-057954
Dec. 9, 2025 (JP) 2025-243474

(51) Int. Cl. H01F 27/29; H01F 17/00

(52) U.S. Cl. CPC H01F 27/292; H01F 17/0013

(57) ABSTRACT

In an inductor, a first internal conductor extends along a first direction, and is not in a wound shape. The inductor can realize a lower inductance compared to a wound internal conductor. In addition, since a first conductor portion and a second conductor portion of the first internal conductor are formed on the substrate using, for example, electrolytic plating, a thickness thereof can be designed without limitation, thereby making the inductance freely adjustable.

### CROSS-REFERENCE TO RELATED APPLICATIONS

This application is based upon and claims the benefit of priority from Japanese Patent Applications No. 2025-57954, filed on 31 Mar. 2025, and No. 2025-243474, filed on 9 Dec. 2025, the entire contents of which are incorporated herein by reference.

### TECHNICAL FIELD

The present disclosure relates to an inductor.

### BACKGROUND

Well known in the art is, as a type of inductor, an inductor in which an internal conductor is configured with a straight conductor. Japanese Unexamined Utility Model Application Publication No. S59-072708 discloses an inductor including a straight conductive layer as an internal conductor between layers of an element body having a laminated structure composed of a plurality of magnetic layers. Such an inductor can more easily achieve a low inductance (low L value) compared to an inductor in which an internal conductor is configured with a wound conductor, as disclosed in Japanese Unexamined Patent Application Publication No. 2016-208002.

### SUMMARY

The inventors have conducted extensive research on the structure of an inductor having a low inductance and have newly found a technology that allows for easy adjustment to a desired low inductance.

According to various aspects of the present disclosure, an inductor is provided in which a low inductance can be easily adjusted.

An inductor according to one aspect of the present disclosure includes an element body, a substrate provided within the element body, having a first principal surface and a second principal surface parallel to each other, and having a base portion extending along a first direction, a first internal conductor provided within the element body on at least one of the first principal surface and the second principal surface in the base portion of the substrate, and a pair of external electrodes provided on a surface of the element body and respectively connected to both ends of the first internal conductor. When viewed from a second direction orthogonal to the first principal surface of the substrate, the first internal conductor extends along the first direction.

### BRIEF DESCRIPTION OF THE DRAWINGS

FIG. 1 is a perspective view showing an inductor according to an embodiment.

FIG. 2 is a cross-sectional view showing the inductor of FIG. 1.

FIG. 3 is a perspective view showing a substrate and a first internal conductor provided within an element body of the inductor of FIG. 1.

FIG. 4 is a plan view showing the substrate provided within the element body of the inductor of FIG. 1.

FIG. 5A is a plan view showing a first principal surface side of the substrate shown in FIG. 3.

FIG. 5B is a plan view showing a second principal surface side of the substrate shown in FIG. 3.

FIG. 6A is a plan view showing a first principal surface side of a substrate according to a different embodiment.

FIG. 6B is a plan view showing a second principal surface side of a substrate according to a different embodiment.

FIG. 7 is a cross-sectional view showing the embodiment of FIGS. 6A and 6B.

FIG. 8A is a plan view showing a first principal surface side of a substrate according to a different embodiment.

FIG. 8B is a plan view showing a second principal surface side of a substrate according to a different embodiment.

FIG. 9 is a cross-sectional view showing the embodiment of FIGS. 8A and 8B.

FIG. 10A is a plan view showing a first principal surface side of a substrate according to a different embodiment.

FIG. 10B is a plan view showing a second principal surface side of a substrate according to a different embodiment.

FIG. 11 is a cross-sectional view showing the embodiment of FIGS. 10A and 10B.

FIG. 12A is a plan view showing a first principal surface side of a substrate according to a different embodiment.

FIG. 12B is a plan view showing a second principal surface side of a substrate according to a different embodiment.

FIG. 13 is a cross-sectional view showing the embodiment of FIGS. 12A and 12B.

FIG. 14A is a plan view showing a first principal surface side of a substrate according to a different embodiment.

FIG. 14B is a plan view showing a second principal surface side of a substrate according to a different embodiment.

FIG. 15 is a cross-sectional view showing the embodiment of FIGS. 14A and 14B.

FIG. 16A is a plan view showing a first principal surface side of a substrate according to a different embodiment.

FIG. 16B is a plan view showing a second principal surface side of a substrate according to a different embodiment.

FIG. 17 is a cross-sectional view showing the embodiment of FIGS. 16A and 16B.

FIG. 18 is a cross-sectional view showing an inductor of a different embodiment.

FIG. 19A is a table showing simulation results.

FIG. 19B is a graph showing simulation results.

FIG. 20 is a perspective view showing an inductor of a different embodiment.

FIG. 21 is a plan view showing a substrate provided within an element body of the inductor of FIG. 20.

FIG. 22 is a plan view showing a first principal surface side of the substrate shown in FIGS. 20 and 21.

FIG. 23 is a plan view showing a second principal surface side of the substrate shown in FIGS. 20 and 21.

FIG. 24 is a perspective view showing an inductor of a different embodiment.

FIG. 25 is a plan view showing a substrate provided within an element body of the inductor of FIG. 24.

FIG. 26 is a plan view showing a first principal surface side of the substrate shown in FIGS. 24 and 25.

FIG. 27 is a plan view showing a second principal surface side of the substrate shown in FIGS. 24 and 25.

### DETAILED DESCRIPTION

Hereinafter, embodiments of the present disclosure will be described in detail with reference to the accompanying drawings. In the description of the drawings, the same or corresponding elements are denoted by the same reference numerals, and redundant description thereof will be omitted.

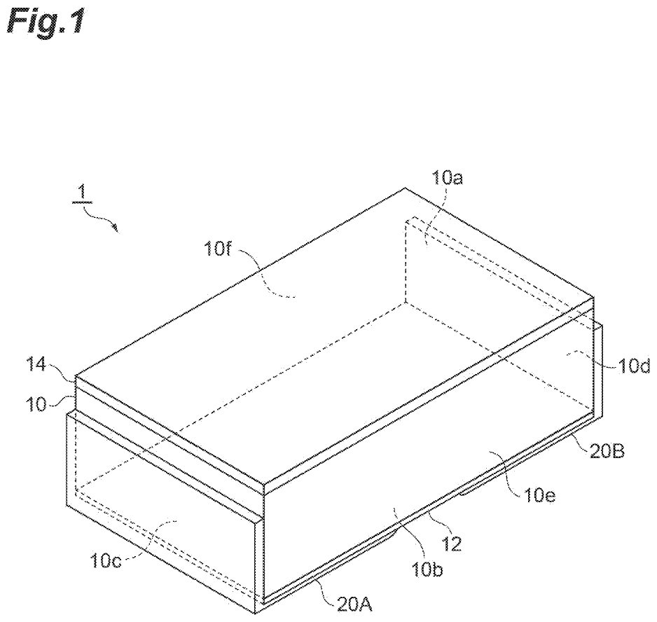

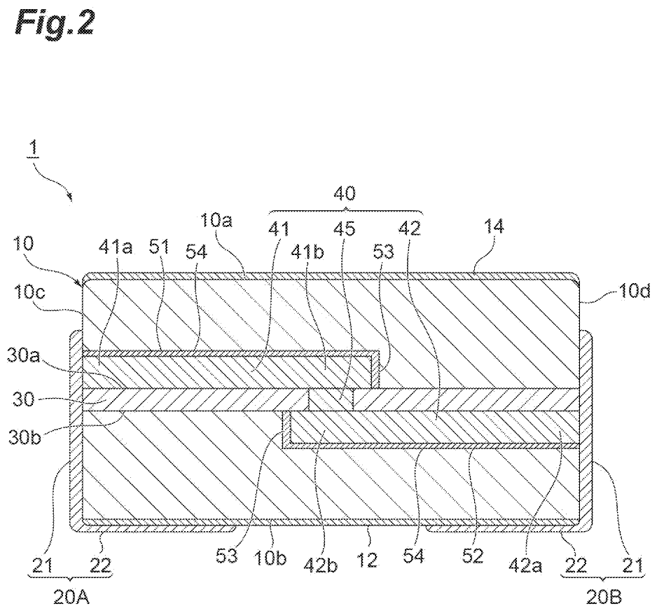

An inductor according to the present embodiment will be described with reference to FIG. 1. As shown in FIGS. 1 and 2, an inductor 1 according to an embodiment is configured to include an element body 10, a pair of terminal electrodes 20A and 20B (external electrodes), a substrate 30, and a first internal conductor 40.

The element body 10 has a rectangular parallelepiped outer shape, and has a pair of main surfaces 10a and 10b parallel to each other, and four side surfaces 10c, 10d, 10e, and 10f connecting the pair of main surfaces 10a and 10b. The rectangular parallelepiped shape in this specification includes a shape of a rectangular parallelepiped in which corners and ridge portions are chamfered, and a shape of a rectangular parallelepiped in which corners and ridge portions are rounded. One main surface 10b of the pair of main surfaces 10a and 10b is a surface facing a mounting substrate on which the inductor 1 is mounted, and is also referred to as a mounting surface in the following description. Each of the main surfaces 10a and 10b has a rectangular shape having a long side and a short side, and in the following description, the side surfaces 10c and 10d connecting the short sides of the main surfaces 10a and 10b are also referred to as end surfaces.

The element body 10 is made of a magnetic powder-containing resin, which is a type of magnetic material. The magnetic powder-containing resin is a bonded powder in which magnetic powder, which will be described later, is bonded by a binder resin. The binder resin is, for example, a thermosetting epoxy resin. In the present embodiment, the content of the magnetic powder in the bonded powder is 75 to 92 vol % in volume percent, and 95 to 99 wt % in mass percent. From the viewpoint of magnetic properties, the content of the magnetic powder in the bonded powder may be 80 to 92 vol % in volume percent and 97to 99 wt % in mass percent.

The pair of terminal electrodes 20A and 20B are L-shaped electrodes that continuously cover the respective end surfaces 10c and 10d and the mounting surface 10b of the element body 10. The terminal electrode 20A includes an end surface covering portion 21 that covers a part of the end surface 10c of the element body and a mounting surface covering portion 22 that covers a part of the mounting surface 10b on the end surface 10c side, and the end surface covering portion 21 and the mounting surface covering portion 22 constitute an L-shaped cross-section. Similarly, the terminal electrode 20B also includes an end surface covering portion 21 that covers a part of the end surface 10d of the element body and a mounting surface covering portion 22 that covers a part of the mounting surface 10b on the end surface 10d side, and the end surface covering portion 21 and the mounting surface covering portion 22 constitute an L-shaped cross-section.

The mounting surface 10b of the element body 10 is entirely covered by a coating material 12. That is, the entire area of the main surface 10b covered by the coating material 12 is not exposed to the outside. The mounting surface 10b in a region between the mounting surface covering portions 22 of the pair of terminal electrodes 20A and 20B is also covered by the coating material 12. The coating material 12 is interposed between the entire area of the mounting surface covering portions 22 of the terminal electrodes 20A and 20B and the mounting surface 10b. That is, the mounting surface covering portions 22 of the terminal electrodes 20A and 20B cover the coating material 12. The coating material 12 is made of an insulating material such as an epoxy-based resin or an acrylic-based resin, and the coating material 12 prevents a short circuit between the pair of terminal electrodes 20A and 20B.

The main surface 10a of the element body 10 is entirely covered by a coating material 14. That is, the entire area of the main surface 10a covered by the coating material 14 is not exposed to the outside. The coating material 14 is made of an insulating material such as an epoxy-based resin or an acrylic-based resin. The constituent material of the coating material 14 covering the main surface 10a may be the same as or different from the constituent material of the coating material 12 covering the mounting surface 10b.

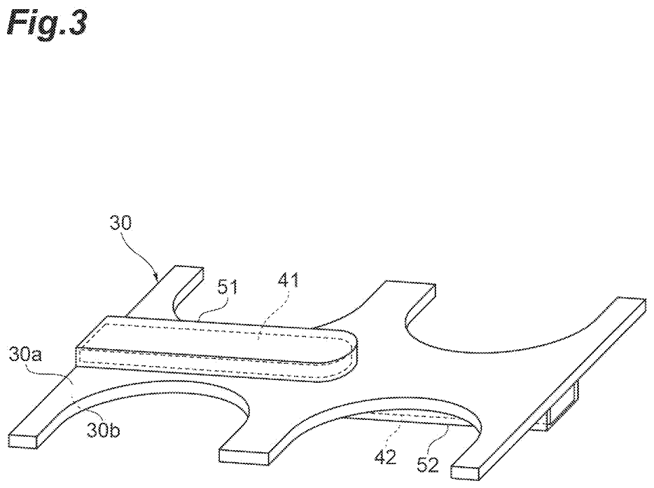

The substrate 30 extends parallel to the main surfaces 10a and 10b as shown in FIG. 2, and has a first principal surface 30a facing the main surface 10a side and a second principal surface 30b facing the mounting surface 10b side as shown in FIG. 3. The first principal surface 30a and the second principal surface 30b are parallel to each other. The substrate 30 is disposed within the element body 10, and can be disposed, for example, at an intermediate position between the main surface 10a and the mounting surface 10b. The substrate 30 extends between the side surface 10c and the side surface 10d, and is exposed from the side surface 10c and the side surface 10d. The thickness of the substrate 30 is 10 to 80 μm (40 μm as an example). The substrate 30 is an insulating substrate made of an insulating material. For the substrate 30, a substrate in which glass cloth is impregnated with a cyanate resin (BT (bismaleimide-triazine) resin: registered trademark) can be used. In addition to BT resin, polyimide, aramid, epoxy, or the like can also be used. As the material for the substrate 30, ceramic or glass can also be used. As the material for the substrate 30, a mass-produced printed circuit board material can be used, and a resin material used for a BT printed circuit board, an FR4 printed circuit board, or an FR5 printed circuit board can be used.

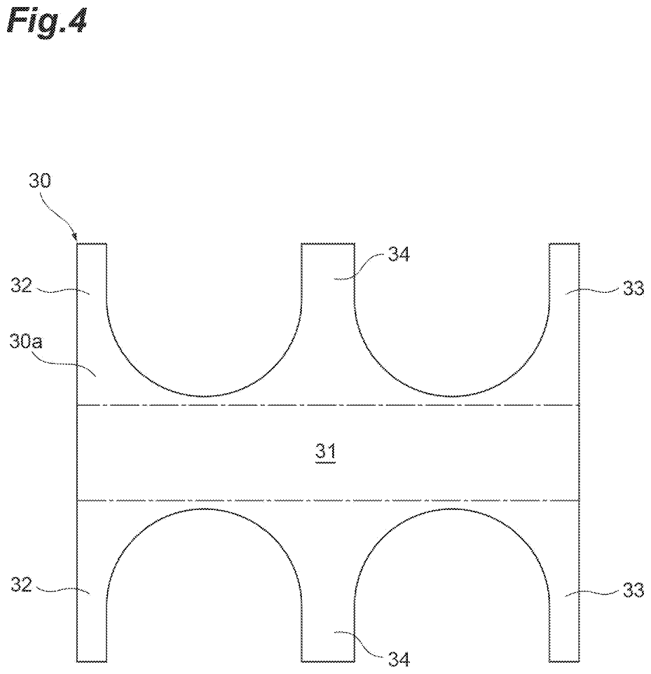

The substrate 30 according to the present embodiment has a base portion 31 that extends along a facing direction of the side surfaces 10c and 10d when viewed from a thickness direction (a second direction) of the substrate 30, as shown in FIG. 4. In the present embodiment, when viewed from the thickness direction of the substrate 30, the base portion 31 has a belt-like shape extending in the facing direction of the side surfaces 10c and 10d, and has a predetermined width. Both end portions of the base portion 31 in the extending direction are respectively exposed from the side surface 10c and the side surface 10d. The first direction, which is the extending direction of the base portion 31, may be the facing direction of the side surfaces 10c and 10d, or may be a direction intersecting the facing direction of the side surfaces 10c and 10d (that is, a direction inclined to some extent from the facing direction of the side surfaces 10c and 10d). Furthermore, the substrate 30 according to the present embodiment has a portion extending in a facing direction of the side surfaces 10e and 10f (that is, a direction orthogonal to the thickness direction of the substrate 30 and the facing direction of the side surfaces 10c and 10d) when viewed from its thickness direction. Specifically, the substrate 30 has a portion 32 that extends from the base portion 31 in the vicinity of the side surface 10c in the facing direction of the side surfaces 10e and 10f and is exposed from the side surface 10c, when viewed from its thickness direction. The substrate 30 also has a portion 33 that extends from the base portion 31 in the vicinity of the side surface 10d in the facing direction of the side surfaces 10e and 10f and is exposed from the side surface 10d, when viewed from its thickness direction. Furthermore, the substrate 30 has a portion 34 that extends from the base portion 31 at an intermediate position between the side surface 10c and the side surface 10d in the facing direction of the side surfaces 10e and 10f and is exposed from each of the side surfaces 10e and 10f, when viewed from the thickness direction.

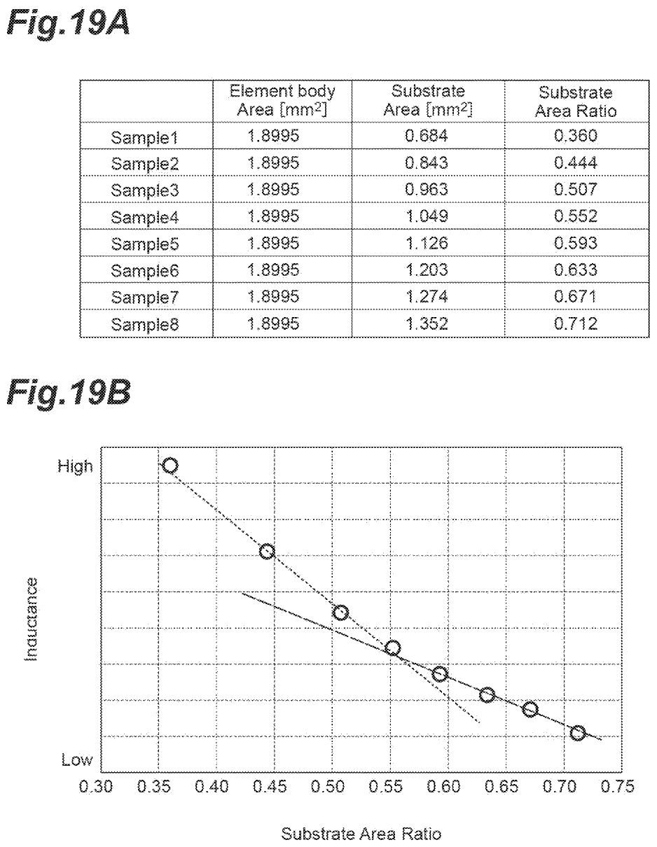

In the present embodiment, when viewed from the thickness direction of the substrate 30, a ratio of an area where the substrate 30 exists to an area of the element body 10 (hereinafter also referred to as a substrate area ratio) is designed to be 0.55 or less. When the substrate area ratio is 0.55 or less, a high inductance is expected. The inventors confirmed the relationship between the substrate area ratio and the inductance by a simulation analysis imitating a 3D model shown below. For the simulation analysis, Maxwell 3D conditions of ANSYS Electronics Desktop software of ANSYS, Inc. were used. That is, the inductance at 1 MHz was measured for each of eight types of inductors (Samples 1 to 8) with different substrate area ratios. In Samples 1 to 8, the area of the element body 10 when viewed from the thickness direction of the substrate 30 was set to a constant value of 1.8995 mm² (length 1.45 mm in the facing direction of the side surfaces 10 c and 10d×length 1.31 mm in the facing direction of the side surfaces 10e and 10f), and only the substrate area was changed. The results were as shown in the table of FIG. 19A and the graph of FIG. 19B. As shown in FIGS. 19A and 19B, the inductance decreases as the substrate area ratio increases, but it was confirmed that a singular point exists where the substrate area ratio is 0.55. That is, the slopes of the approximate straight lines for Samples 1 to 3 and the approximate straight lines for Samples 4 to 7 were significantly different, and the substrate area ratio at their intersection was 0.55. From the above results, it was confirmed that when the substrate area ratio is 0.55 or less, a higher inductance can be obtained compared to the case where the substrate area ratio exceeds 0.55.

The first internal conductor 40 is formed on the substrate 30 within the element body 10. The first internal conductor 40 according to the present embodiment is configured to include two conductor portions, and includes a first conductor portion 41 formed on the first principal surface 30a in the base portion 31 of the substrate 30 and a second conductor portion 42 formed on the second principal surface 30b in the base portion 31. The first conductor portion 41 and the second conductor portion 42 formed on the base portion 31 extend along a first direction in which the base portion 31 extends, and in the present embodiment, extend along the facing direction of the side surfaces 10c and 10d. Therefore, when viewed from the thickness direction of the substrate 30, the outer shape of the first internal conductor 40 as a whole has a shape extending along the first direction in which the base portion 31 extends. Furthermore, when viewed from the thickness direction of the substrate 30, the outer shape of the first internal conductor 40 is line-symmetrical with respect to a reference line L parallel to the first direction in which the base portion 31 extends.

The first conductor portion 41 and the second conductor portion 42 of the first internal conductor 40 can be made of, for example, copper, and can be formed by electrolytic plating.

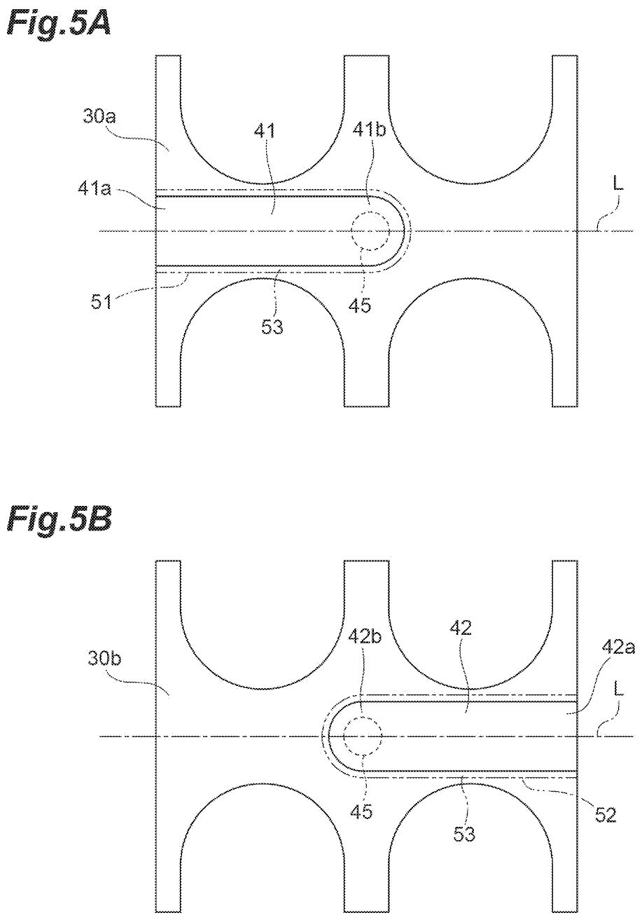

As shown in FIG. 5A, the first conductor portion 41 extends on the first principal surface 30a from the side surface 10c to the vicinity of an intermediate position between the side surface 10c and the side surface 10d. The first conductor portion 41 has a first end portion 41a close to the side surface 10c and a second end portion 41b away from the side surface 10c, and is designed to have a uniform width between the first end portion 41a and the second end portion 41b. The first conductor portion 41 has a rectangular cross-sectional shape in a cross-section orthogonal to its extending direction. Regarding the cross-sectional dimensions of the first conductor portion 41, its width is 100 to 800 μm (200 μm as an example), and its height is 40 to 400 μm (200 μm as an example). The first end portion 41a of the first conductor portion 41 is exposed from the side surface 10c and is electrically connected to the end surface covering portion 21 of the terminal electrode 20A that covers the side surface 10c. The second end portion 41b of the first conductor portion 41 is rounded into a semicircular shape when viewed from the thickness direction of the substrate 30, and terminates in the vicinity of the intermediate position between the side surface 10c and the side surface 10d.

As shown in FIG. 5B, the second conductor portion 42 extends on the second principal surface 30b from the side surface 10d to the vicinity of an intermediate position between the side surface 10c and the side surface 10d. The second conductor portion 42 has a first end portion 42a close to the side surface 10d and a second end portion 42b away from the side surface 10d, and is designed to have a uniform width between the first end portion 42a and the second end portion 42b. The second conductor portion 42 has a rectangular cross-sectional shape in a cross-section orthogonal to its extending direction. The cross-sectional dimensions of the second conductor portion 42 are designed to be the same as the cross-sectional dimensions of the first conductor portion 41. The first end portion 42a of the second conductor portion 42 is exposed from the side surface 10d and is electrically connected to the end surface covering portion 21 of the terminal electrode 20B that covers the side surface 10d. The second end portion 42b of the second conductor portion 42 is rounded into a semicircular shape when viewed from the thickness direction of the substrate 30, and terminates in the vicinity of the intermediate position between the side surface 10c and the side surface 10d.

As shown in FIG. 2, the second end portion 41b of the first conductor portion 41 and the second end portion 42b of the second conductor portion 42 overlap in the thickness direction of the substrate 30. The first internal conductor 40 further includes a via conductor 45 that penetrates the substrate 30 in its thickness direction, and the second end portion 41b of the first conductor portion 41 and the second end portion 42b of the second conductor portion 42 are electrically connected by the via conductor 45. The via conductor 45 according to the present embodiment has a cylindrical outer shape and has a circular shape when viewed from the thickness direction of the substrate 30. The via conductor 45 is provided in a through-hole provided in the substrate 30. The diameter of the via conductor 45 (that is, the diameter of the through-hole) is 20 to 60 μm (40 μm as an example). The diameter of the via conductor 45 can be designed to be twice the thickness of the substrate 30 or less. The via conductor 45 can be made of, for example, copper, and can be formed by electrolytic plating. When the diameter of the via conductor 45 is twice the thickness of the substrate 30 or less, the via conductor 45 can be provided so as to reliably fill the inside of the through-hole by electrolytic plating.

As described above, since the first end portion 41a of the first conductor portion 41 is connected to the terminal electrode 20A at the side surface 10c, and the first end portion 42a of the second conductor portion 42 is connected to the terminal electrode 20B at the side surface 10d, the first internal conductor 40 as a whole constitutes a single conductor provided across the pair of terminal electrodes 20A and 20B.

The surfaces of the first conductor portion 41 and the second conductor portion 42 of the first internal conductor 40 are entirely covered by insulators 51 and 52, as shown in FIGS. 2, 3, 5A, and 5B. The insulators 51 and 52 provide insulation between the material constituting the element body 10 and the first conductor portion 41 and the second conductor portion 42. The insulators 51 and 52 are made of an insulating material such as an epoxy-based resin. Specifically, the first conductor portion 41 is covered by the insulator 51 on the first principal surface 30a, and the second conductor portion 42 is covered by the insulator 52 on the second principal surface 30b. Each of the insulators 51 and 52 has a side surface covering portion 53 that covers the side surfaces of the conductor portions 41 and 42 and a top surface covering portion 54 that covers the top surfaces of the conductor portions 41 and 42. The thickness of the side surface covering portion 53 of the insulators 51 and 52 is, for example, 10 to 40 μm (20 μm as an example), and the thickness of the top surface covering portion 54 is, for example, 1 to 40 μm (10 μm as an example). The insulating material constituting the side surface covering portion 53 and the insulating material constituting the top surface covering portion 54 may be the same or different.

In the present embodiment, the side surface covering portions 53 of the insulators 51 and 52 are formed from a resist provided on the substrate 30. That is, the resist provided on the substrate 30 is patterned to form the side surface covering portions 53 that stand substantially perpendicular to the principal surfaces 30a and 30b. The conductor portions 41 and 42 can be formed by electrolytic plating so as to fill a space defined by the side surface covering portions 53. The top surface covering portions 54 of the insulators 51 and 52 are formed so as to cover the top surfaces of the conductor portions 41 and 42 after the conductor portions 41 and 42 are formed.

The cross-sectional shape of the conductor portions 41 and 42 (more specifically, the cross-sectional shape in a cross-section orthogonal to the extending direction) is determined by the dimensions of the plating filling space defined by the side surface covering portions 53 of the insulators 51 and 52, or by plating conditions such as plating time. That is, the height of the conductor portions 41 and 42 can be freely adjusted by, for example, adjusting the height of the resist provided on the substrate 30, and the height of the conductor portions 41 and 42 can also be freely adjusted by adjusting the plating time.

As described above, in the inductor 1, the first internal conductor 40 extends along the first direction, which is the extending direction of the base portion 31 of the substrate 30, and is not in a wound shape. Therefore, the inductor 1 can realize a lower inductance compared to a wound internal conductor. In addition, since the first conductor portion 41 and the second conductor portion 42 of the first internal conductor 40 are formed on the substrate 30 using, for example, electrolytic plating or the like, in particular, their thickness (length in the thickness direction of the substrate 30) can be designed without limitation, thereby making the inductance freely adjustable. On the other hand, in an inductor according to the related art in which a conductor layer is provided between layers of an element body having a laminated structure, the inductance can only be adjusted in discrete values because it is limited by the thickness of the conductor layer (or an integer multiple thereof), making fine adjustment difficult.

The first direction, which is the extending direction of the base portion 31 of the substrate 30, does not necessarily have to coincide with the facing direction of the side surfaces 10c and 10d, and may be a direction intersecting the facing direction of the side surfaces 10c and 10d. In this case, the first internal conductor 40 can also extend in a direction intersecting the facing direction of the side surfaces 10c and 10d. Furthermore, the first internal conductor 40 may meander like a meander coil as long as it extends along the first direction.

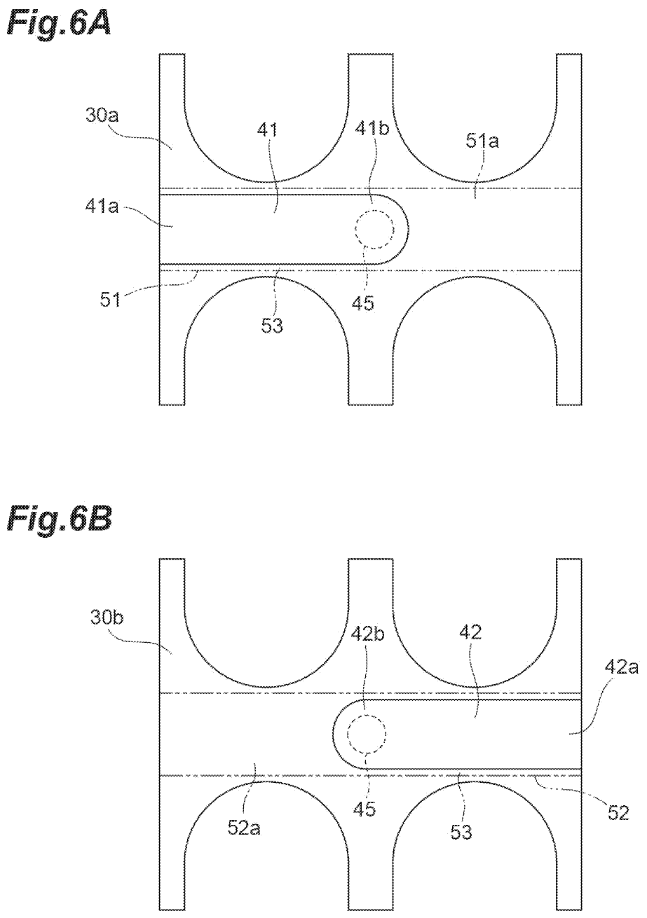

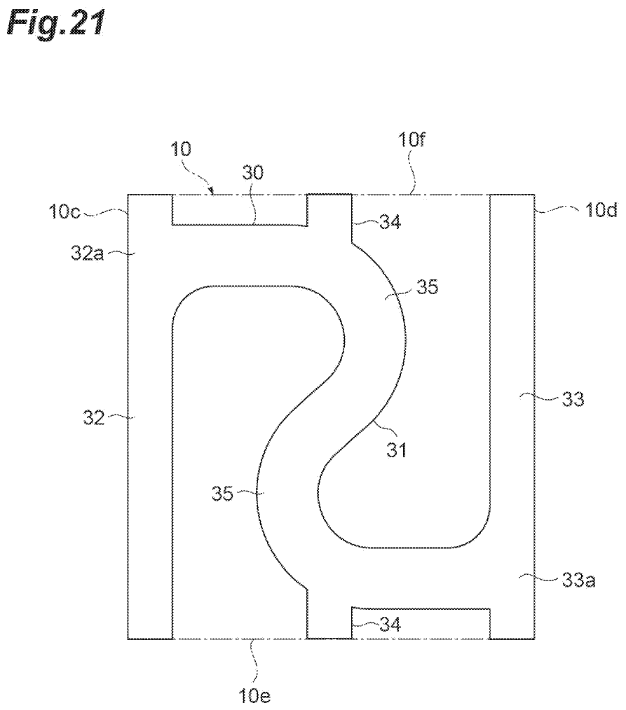

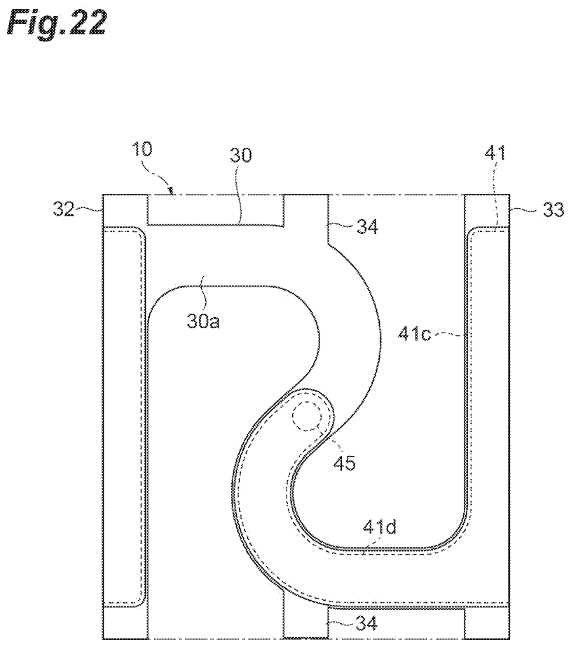

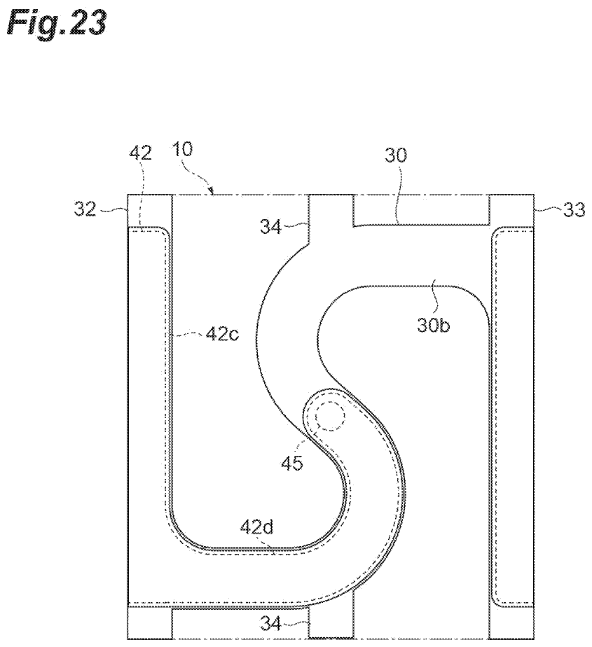

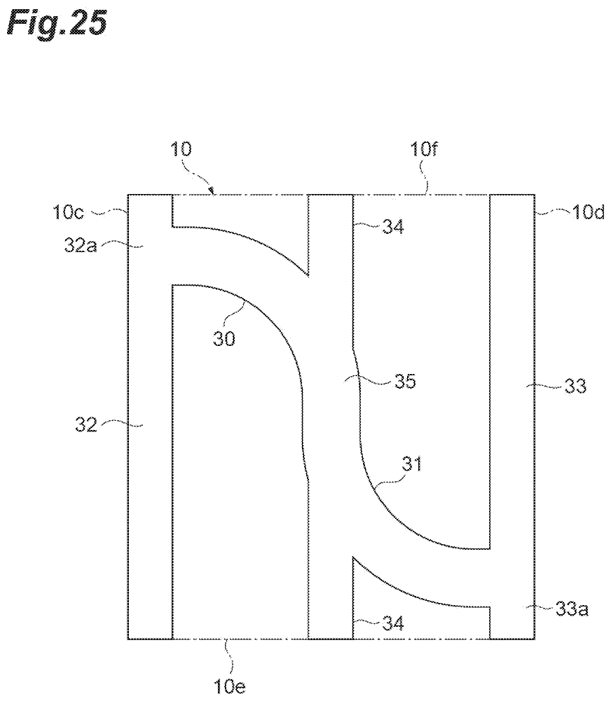

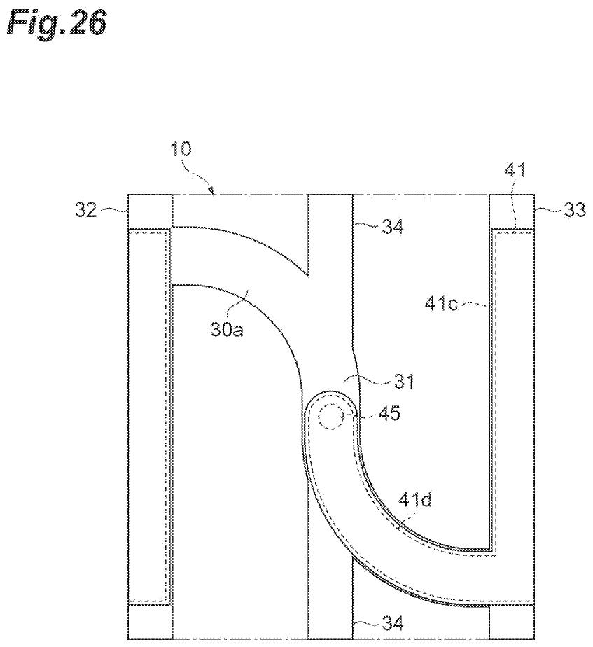

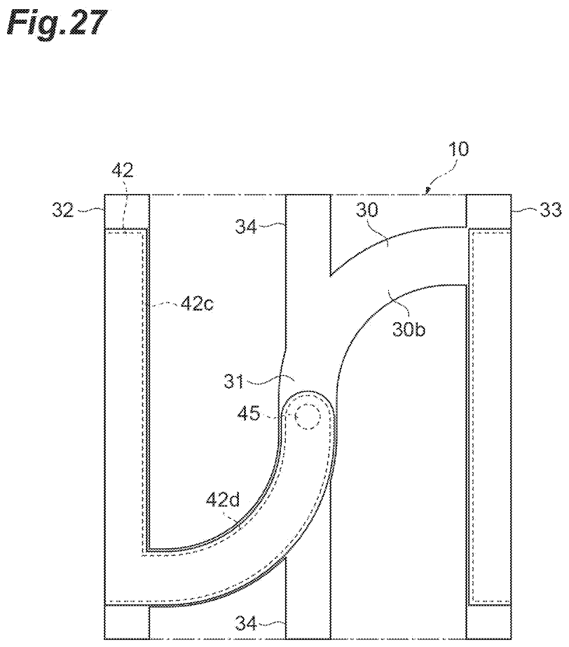

The inductor 1 is not limited to the above-described embodiment and can take various forms. Hereinafter, inductors of embodiments different from the above-described embodiment will be described with reference to FIGS. 6A, 6B, 7, 8A, 8B, 9, 10A, 10B, 11, 12A, 12B, 13, 14A, 14B, 15, 16A, 16B, 17, 18, and 20 to 27.

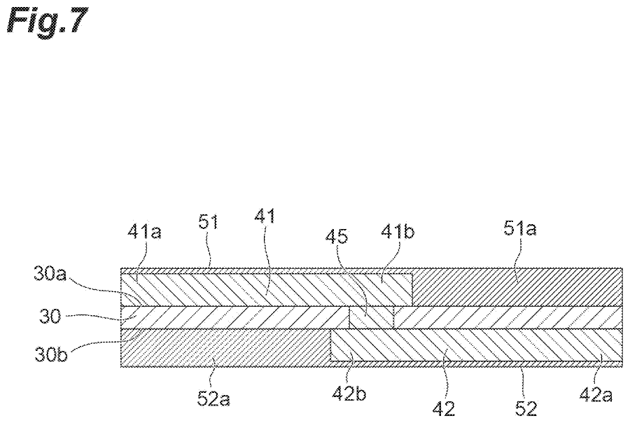

In the embodiment shown in FIGS. 6A, 6B, and 7, the insulators 51 and 52 cover the surfaces of the first conductor portion 41 and the second conductor portion 42, and extend over the entire length between the side surfaces 10c and 10d on the base portion 31 of the substrate 30. The insulator 51 has an insulator portion 51a that overlaps with a part of the second conductor portion 42 via the substrate 30. The top surface of the insulator 51 is a smooth surface (without steps) over its entirety, from a portion covering the surface of the first conductor portion 41 to the insulator portion 51a. The insulator 52 has an insulator portion 52a that overlaps with a part of the first conductor portion 41 via the substrate 30. The top surface of the insulator 52, similar to the top surface of the insulator 51, is a smooth surface (without steps) over its entirety, from a portion covering the surface of the second conductor portion 42 to the insulator portion 52a. When the top surfaces of the insulators 51 and 52 are smooth, they are stable when placed on a flat surface, which improves workability in the manufacturing process and reduces internal stress in the substrate 30 and the first internal conductor 40.

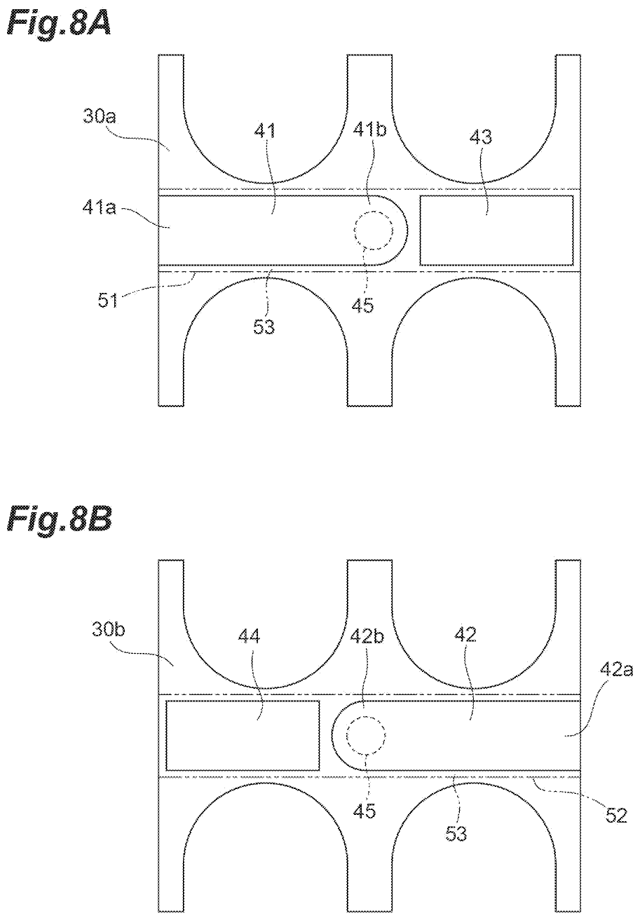

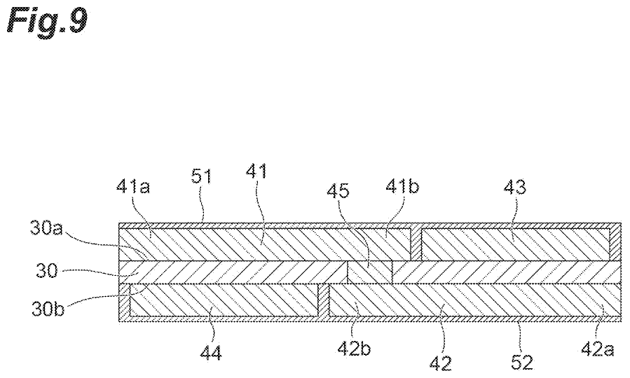

In the embodiment shown in FIGS. 8A, 8B, and 9, a third conductor portion 43 aligned with the first conductor portion 41 on the first principal surface 30a, and a fourth conductor portion 44 aligned with the second conductor portion 42 on the second principal surface 30b are provided as a second internal conductor insulated from the first internal conductor 40. The third conductor portion 43 is adjacent to the first conductor portion 41 with respect to the first direction, which is the extending direction of the base portion 31, and has a shape extending along the first direction. The first conductor portion 41 and the third conductor portion 43 are separated from each other and are insulated by an insulator 51 that integrally covers the first conductor portion 41 and the third conductor portion 43. The cross-sectional shape of the third conductor portion 43 may be the same as or different from the cross-sectional shape of the first conductor portion 41. The fourth conductor portion 44 is adjacent to the second conductor portion 42 with respect to the first direction, and has a shape extending along the first direction. The second conductor portion 42 and the fourth conductor portion 44 are separated from each other and are insulated by an insulator 52 that integrally covers the second conductor portion 42 and the fourth conductor portion 44. The cross-sectional shape of the fourth conductor portion 44 may be the same as or different from the cross-sectional shape of the second conductor portion 42.

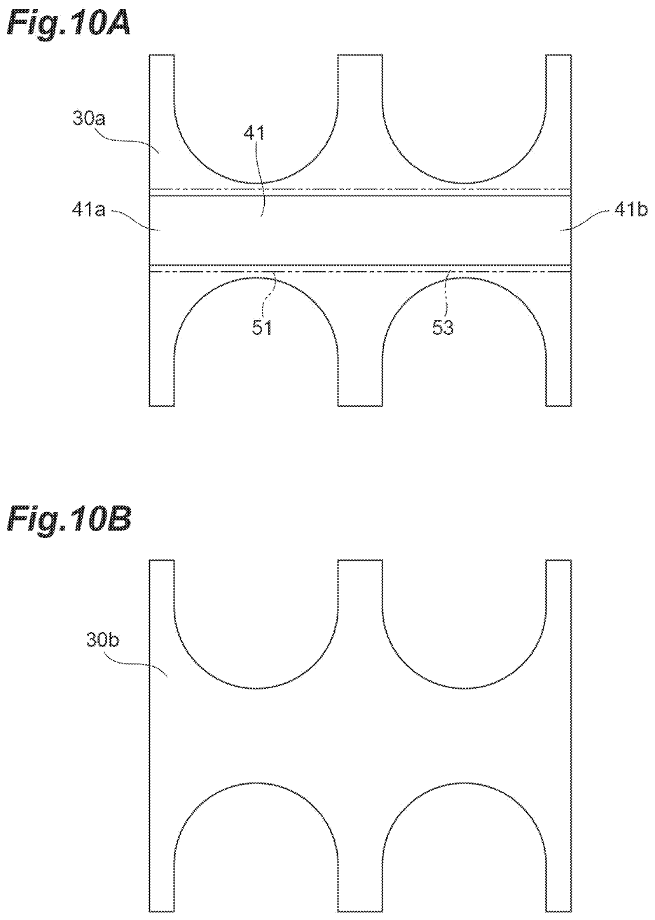

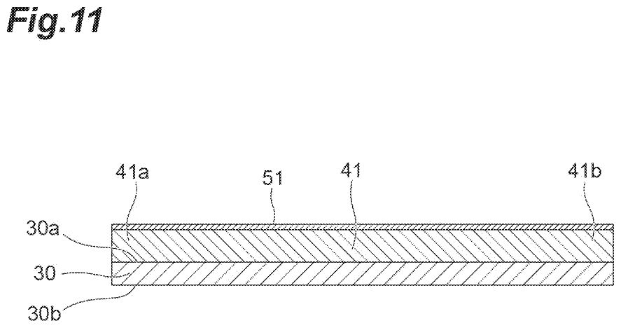

In the embodiment shown in FIGS. 10A, 10B, and 11, the first internal conductor 40 is composed only of the first conductor portion 41 provided on the first principal surface 30a. Neither the above-described second conductor portion 42 nor the insulator 52 is provided on the second principal surface 30b. The first conductor portion 41 extends over the entire length between the side surfaces 10c and 10d, and its second end portion 41b is exposed from the side surface 10d and is electrically connected to the end surface covering portion 21 of the terminal electrode 20B. Conversely, the first internal conductor 40 may be composed only of the second conductor portion 42 provided on the second principal surface 30b. In this case, the second conductor portion 42 extends over the entire length between the side surfaces 10c and 10d, and its second end portion 42b is exposed from the side surface 10c and is electrically connected to the end surface covering portion 21 of the terminal electrode 20A.

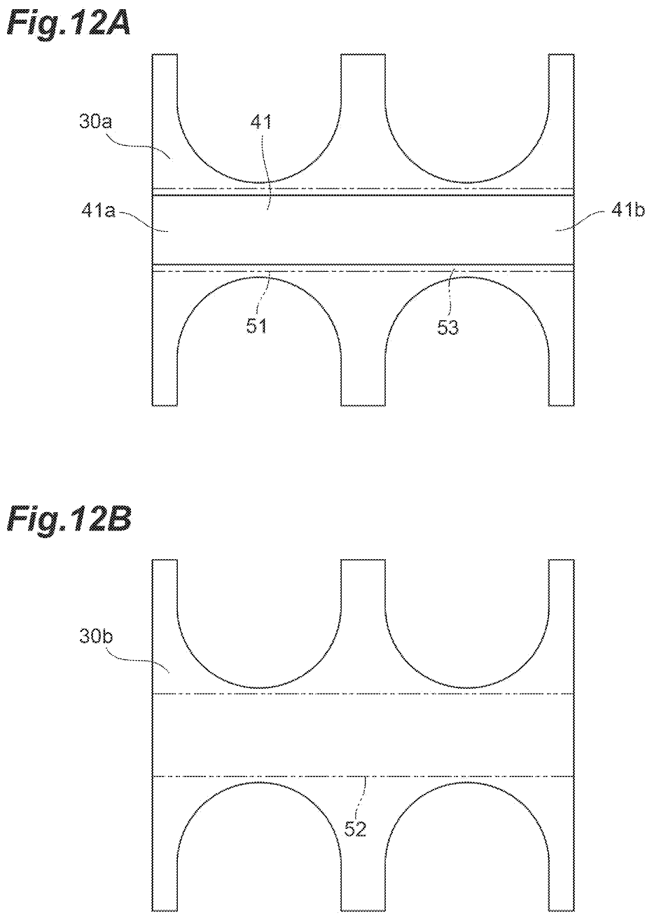

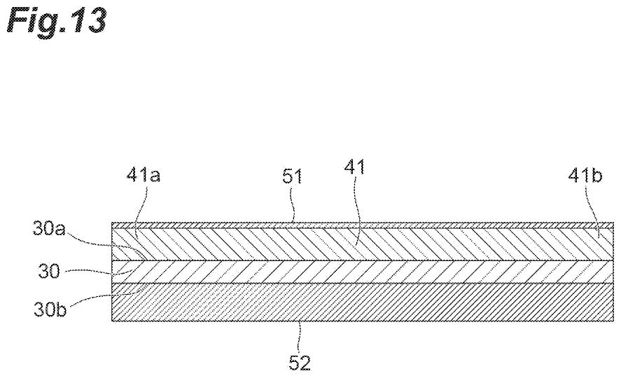

In the embodiment shown in FIGS. 12A, 12B, and 13, similar to the embodiment shown in FIGS. 10A, 10B, and 11, the first internal conductor 40 is composed only of the first conductor portion 41 provided on the first principal surface 30a. Only the insulator 52 is provided on the second principal surface 30b. The first conductor portion 41 extends over the entire length between the side surfaces 10c and 10d, and its second end portion 41b is exposed from the side surface 10d and is electrically connected to the end surface covering portion 21 of the terminal electrode 20B. The insulator 52 extends over the entire length between the side surfaces 10c and 10d.

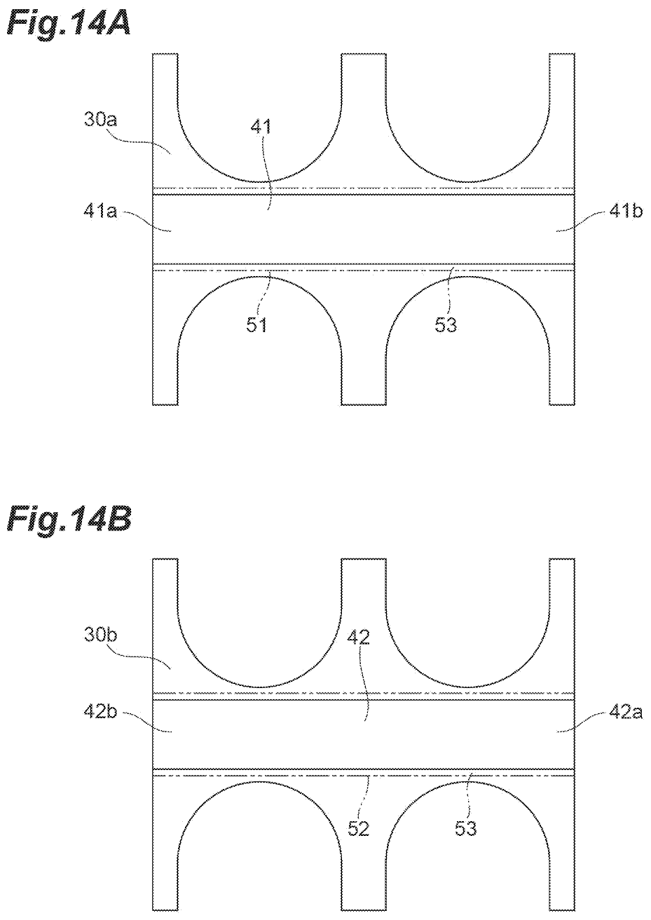

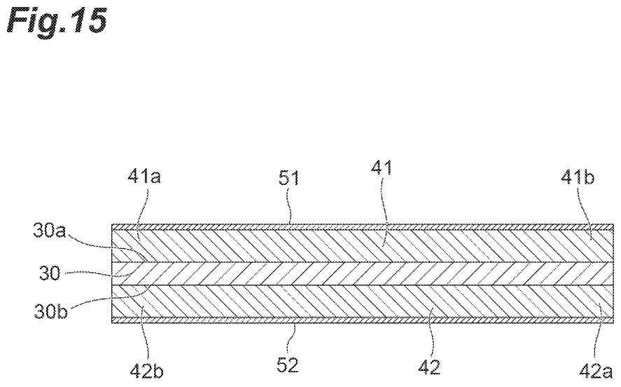

In the embodiment shown in FIGS. 14A, 14B, and 15, the via conductor 45 is not provided, and the first conductor portion 41 and the second conductor portion 42 of the first internal conductor 40 are insulated from each other. The first conductor portion 41 extends over the entire length between the side surfaces 10c and 10d, and its second end portion 41b is exposed from the side surface 10d and is electrically connected to the end surface covering portion 21 of the terminal electrode 20B. The second conductor portion 42 extends over the entire length between the side surfaces 10c and 10d, and its second end portion 42b is exposed from the side surface 10c and is electrically connected to the end surface covering portion 21 of the terminal electrode 20A. In this case, the first conductor portion 41 and the second conductor portion 42 have a relationship of being connected in parallel between the terminal electrodes 20A and 20B. Since the inductor 1 functions with only one of the first conductor portion 41 and the second conductor portion 42, the other of the first conductor portion 41 and the second conductor portion 42 may be divided by a gap, or may be separated from the side surfaces 10c and 10d (that is, insulated from the terminal electrodes 20A and 20B).

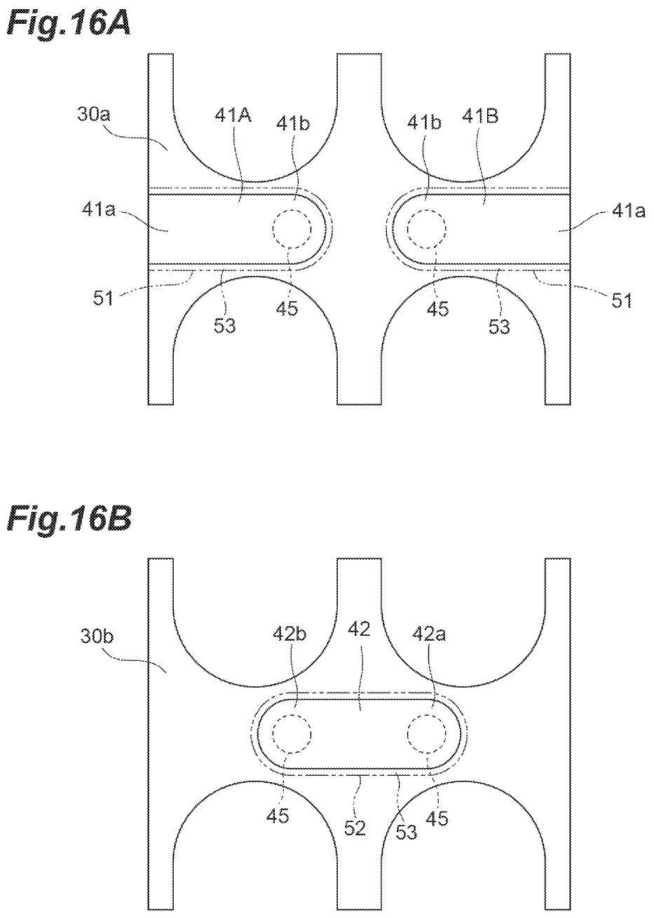

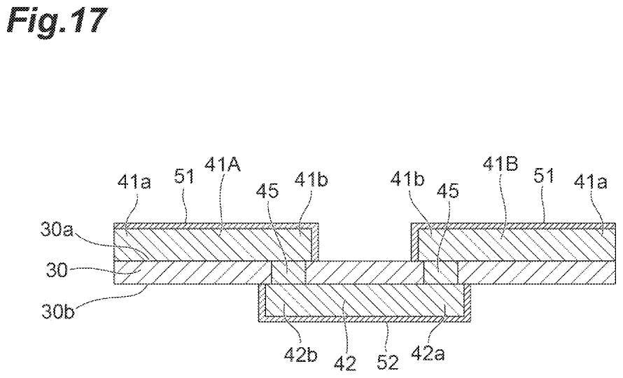

In the embodiment shown in FIGS. 16A, 16B, and 17, the first internal conductor 40 is configured to include three conductor portions, and includes two first conductor portions 41A and 41B formed on the first principal surface 30a and one second conductor portion 42 formed on the second principal surface 30b. The first conductor portion 41A and the first conductor portion 41B are adjacent to each other with respect to the first direction, with the first conductor portion 41A located on the side surface 10c side and the first conductor portion 41B located on the side surface 10d side. Both the first conductor portion 41A and the first conductor portion 41B have a shape extending along the first direction, similar to the above-described first conductor portion 41. The lengths of the first conductor portion 41A and the first conductor portion 41B in the first direction may be the same or different.

A first end portion 41a of the first conductor portion 41A, which is close to the side surface 10c, is exposed from the side surface 10c and is electrically connected to the end surface covering portion 21 of the terminal electrode 20A. A second end portion 41b of the first conductor portion 41A, which is away from the side surface 10c, terminates in the middle of the base portion 31. A first end portion 41a of the first conductor portion 41B, which is close to the side surface 10d, is exposed from the side surface 10d and is electrically connected to the end surface covering portion 21 of the terminal electrode 20B. A second end portion 41b of the first conductor portion 41B, which is away from the side surface 10d, terminates in the middle of the base portion 31. The second conductor portion 42 has a shape extending along the first direction, similar to the above-described second conductor portion 42. Both end portions 42a and 42b of the second conductor portion 42 are separated from the side surfaces 10c and 10d and are not exposed from the side surfaces 10c and 10d. The second end portion 42b of the second conductor portion 42, which is close to the side surface 10c, overlaps with the second end portion 41b of the first conductor portion 41A in the thickness direction of the substrate 30, and is electrically connected by a via conductor 45. The first end portion 42a of the second conductor portion 42, which is close to the side surface 10d, overlaps with the second end portion 41b of the first conductor portion 41B in the thickness direction of the substrate 30, and is electrically connected by a via conductor 45. The first internal conductor 40 including the three conductor portions 41A, 41B, and 42 as a whole constitutes a single conductor provided across the pair of terminal electrodes 20A and 20B.

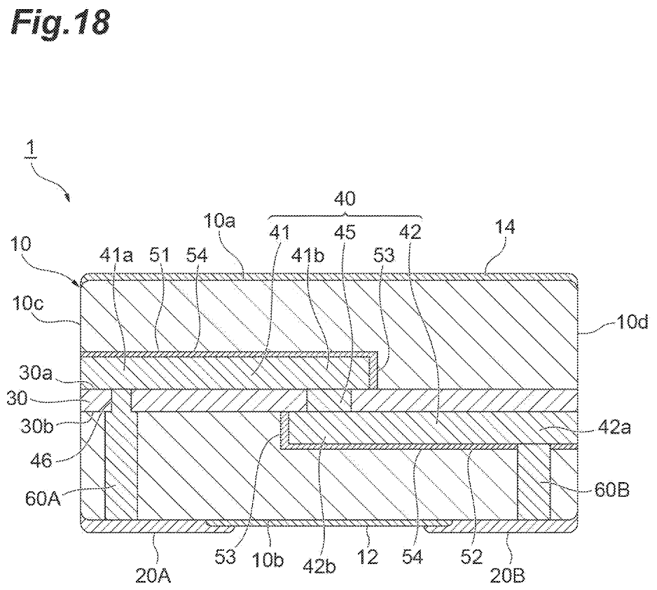

As shown in FIG. 18, the inductor 1 may further include a pair of connection conductors 60A and 60B that extend in the thickness direction within the element body 10 and connect each of both end portions of the first internal conductor 40 (that is, the first end portion 41a of the first conductor portion 41 and the first end portion 42a of the second conductor portion 42) to the terminal electrodes 20A and 20B of a portion provided on the mounting surface 10b. In this case, the terminal electrodes 20A and 20B may be L-shaped electrodes that continuously cover the respective side surfaces 10c and 10d and the mounting surface 10b of the element body 10 as shown in FIG. 2, or may be a bottom electrode type in which the terminal electrodes 20A and 20B are provided only on the mounting surface 10b of the element body 10 as shown in FIG. 18. The first end portion 41a of the first conductor portion 41 can be electrically connected to the connection conductor 60A and the terminal electrode 20A via a via conductor 46 provided in the substrate 30. Both end portions of the substrate 30 and the first internal conductor 40 may or may not be exposed from the side surfaces 10c and 10d.

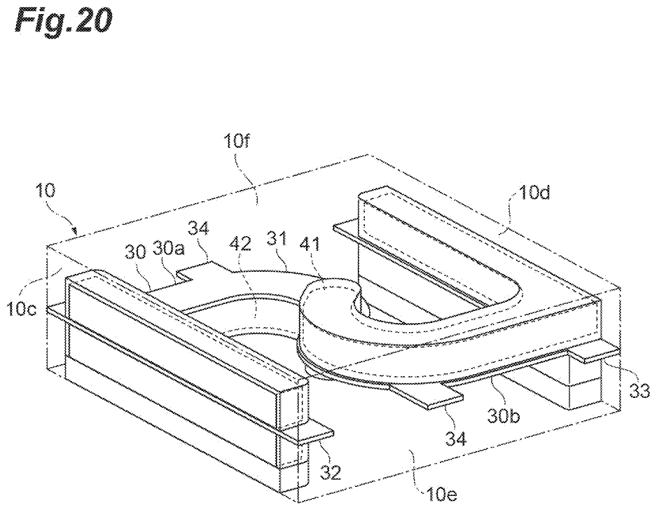

In the embodiment shown in FIGS. 20 to 23, when viewed from the thickness direction of the substrate 30, the substrate 30 has a base portion 31 that extends in a meandering manner, a portion 32 that extends in the vicinity of the side surface 10c in the facing direction of the side surfaces 10e and 10f and is exposed from the side surface 10c, a portion 33 that extends in the vicinity of the side surface 10d in the facing direction of the side surfaces 10e and 10f and is exposed from the side surface 10d, and a portion 34 that extends from the base portion 31 at an intermediate position between the side surface 10c and the side surface 10d in the facing direction of the side surfaces 10e and 10f and is exposed from each of the side surfaces 10e and 10f.

In the present embodiment, the base portion 31 has an inverted S-shape (a mirror-inverted S-shape), has a predetermined width, and includes two portions 35 that are locally parallel to the facing direction of the side surfaces 10e and 10f. An end portion 31a on the side surface 10c side of the base portion 31 is integrally connected to the portion 32 at an end portion 32a on the side surface 10f side of the portion 32, and an end portion 31b on the side surface 10d side of the base portion 31 is integrally connected to the portion 33 at an end portion 33a on the side surface 10e side of the portion 33.

The first conductor portion 41 has an exposed portion 41c that extends on the portion 33 of the first principal surface 30a in the facing direction of the side surfaces 10e and 10f and is exposed from the side surface 10d, and a meandering portion 41d that meanders along the base portion 31 on the base portion 31 of the first principal surface 30a and extends to the vicinity of a center position of the base portion 31. The exposed portion 41c is designed to have a uniform width over its entire length, and the meandering portion 41d is also designed to have a uniform width over its entire length. Both the exposed portion 41c and the meandering portion 41d have a rectangular cross-sectional shape in a cross-section orthogonal to their extending direction. The exposed portion 41c is exposed from the side surface 10d and is electrically connected to the end surface covering portion 21 of the terminal electrode 20B that covers the side surface 10d. One end of the meandering portion 41d is integrally connected to the exposed portion 41c at an end portion on the side surface 10e side of the exposed portion 41c, and the other end of the meandering portion 41d is rounded into a semicircular shape when viewed from the thickness direction of the substrate 30, and terminates in the vicinity of the center position of the base portion 31.

The second conductor portion 42 has an exposed portion 42c that extends on the portion 32 of the second principal surface 30b in the facing direction of the side surfaces 10e and 10f and is exposed from the side surface 10c, and a meandering portion 42d that meanders along the base portion 31 on the base portion 31 of the second principal surface 30b and extends to the vicinity of a center position of the base portion 31. The exposed portion 42c is designed to have a uniform width over its entire length, and the meandering portion 42d is also designed to have a uniform width over its entire length. Both the exposed portion 42c and the meandering portion 42d have a rectangular cross-sectional shape in a cross-section orthogonal to their extending direction. The exposed portion 42c is exposed from the side surface 10c and is electrically connected to the end surface covering portion 21 of the terminal electrode 20A that covers the side surface 10c. One end of the meandering portion 42d is integrally connected to the exposed portion 42c at an end portion on the side surface 10f side of the exposed portion 42c, and the other end of the meandering portion 42d is rounded into a semicircular shape when viewed from the thickness direction of the substrate 30, and terminates in the vicinity of the center position of the base portion 31. The meandering portion 41d of the first conductor portion 41 and the meandering portion 42d of the second conductor portion 42 overlap each other in the thickness direction of the substrate 30 in the vicinity of the center position of the base portion 31, and are electrically connected by a via conductor 45 that penetrates the substrate 30 in its thickness direction.

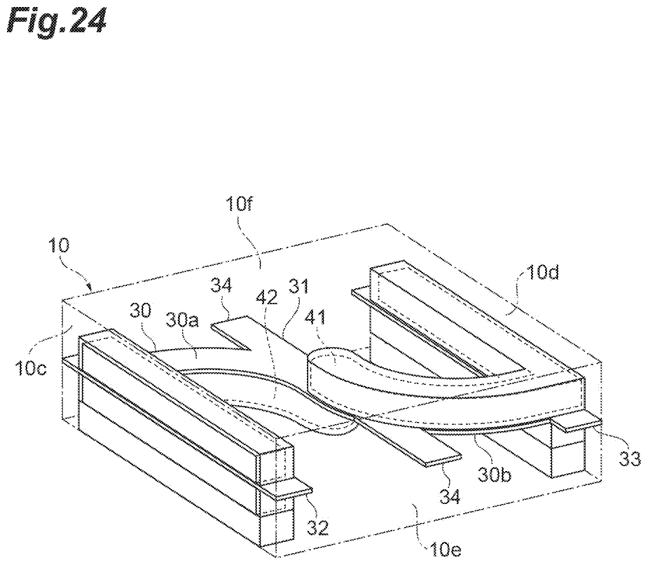

In the embodiment shown in FIGS. 24 to 27, the base portion 31 also has an inverted S-shape (a mirror-inverted S-shape), but has a smaller curvature than the base portion 31 of the embodiment shown in FIGS. 20 to 23, and includes one portion 35 that is locally parallel to the facing direction of the side surfaces 10e and 10f in the vicinity of the center position of the base portion 31. In the embodiment shown in FIGS. 24 to 27, similar to the embodiment shown in FIGS. 20 to 23, the first conductor portion 41 has an exposed portion 41c that extends on the portion 33 of the first principal surface 30a in the facing direction of the side surfaces 10e and 10f and is exposed from the side surface 10d, and a meandering portion 41d that meanders along the base portion 31 on the base portion 31 of the first principal surface 30a and extends to the vicinity of a center position of the base portion 31. The second conductor portion 42 also has an exposed portion 42c that extends on the portion 32 of the second principal surface 30b in the facing direction of the side surfaces 10e and 10f and is exposed from the side surface 10c, and a meandering portion 42d that meanders along the base portion 31 on the base portion 31 of the second principal surface 30b and extends to the vicinity of a center position of the base portion 31.

In the embodiment shown in FIGS. 20 to 23 and the embodiment shown in FIGS. 24 to 27, when viewed from the thickness direction of the substrate 30, the meandering portion 41d of the first conductor portion 41 and the meandering portion 42d of the second conductor portion 42 are composed of curved portions and do not include bent portions. If they were to include bent portions, it is conceivable that cracks could occur in those portions, or that damage or peeling of the insulators 51 and 52 could occur. If the meandering portion 41d of the first conductor portion 41 or the meandering portion 42d of the second conductor portion 42 is formed by bending a conductor such as a metal plate, it is conceivable that a restoring force (springback) could occur in the bent portion, making it impossible to maintain the shape.

In the embodiment shown in FIGS. 20 to 23 and the embodiment shown in FIGS. 24 to 27, when viewed from the thickness direction of the substrate 30, the meandering portion 41d of the first conductor portion 41 and the meandering portion 42d of the second conductor portion 42 meander along the base portion 31; in other words, the base portion 31 meanders along the meandering portion 41d of the first conductor portion 41 and the meandering portion 42d of the second conductor portion 42. That is, the base portion 31 is provided only in the area necessary for forming the meandering portion 41d of the first conductor portion 41 and the meandering portion 42d of the second conductor portion 42, which saves space for the base portion 31, and therefore, a sufficient magnetic volume of the magnetic material (magnetic powder-containing resin) constituting the element body 10 can be secured. This facilitates an inductance adjustment and makes it possible to realize an abundant lineup of low inductance products. Furthermore, when viewed from the thickness direction of the substrate 30, the connection between the ends of the meandering portions 41d and 42d and the ends of the exposed portions 41c and 42c is at diagonal positions in the element body 10, so that they are widely separated from each other, and the magnetic fluxes generated at the two joint locations are less likely to affect each other (for example, cancel each other out). This facilitates an inductance adjustment and can improve the inductance.

As described above, the present specification also discloses the following appendixes.
[Appendix 1] An inductor, comprising:
   an element body having a pair of side surfaces;
   a substrate provided within the element body, having a first principal surface and a second principal surface parallel to each other, and having a base portion extending in a meandering manner between the pair of side surfaces;
   a first internal conductor provided within the element body on at least one of the first principal surface and the second principal surface in the base portion of the substrate; and
   a pair of external electrodes provided on a surface of the element body and respectively connected to both ends of the first internal conductor,
   wherein, when viewed from a second direction orthogonal to the first principal surface of the substrate, the first internal conductor extends along the base portion.
[Appendix 2] The inductor according to Appendix 1,
   wherein the substrate further has a pair of portions exposed at the pair of side surfaces, respectively, and extending along the side surfaces, and
   wherein the first internal conductor has:
      a pair of exposed portions extending along the side surfaces on the pair of portions and exposed from the pair of side surfaces, respectively; and
      a meandering portion meandering along the base portion on the base portion.
[Appendix 3] The inductor according to Appendix 1 or 2,
   wherein, when viewed from the second direction, a connection between an end of the meandering portion and an end of the pair of exposed portions is in a diagonal positional relationship.

What is claimed is:

1. An inductor, comprising:
an element body;
a substrate provided within the element body, having a first principal surface and a second principal surface parallel to each other, and having a base portion extending along a first direction;
a first internal conductor provided within the element body on at least one of the first principal surface and the second principal surface in the base portion of the substrate; and
a pair of external electrodes provided on a surface of the element body and respectively connected to both ends of the first internal conductor,
wherein, when viewed from a second direction orthogonal to the first principal surface of the substrate, the first internal conductor extends along the first direction.

2. The inductor according to claim 1, wherein the first internal conductor has a plurality of conductor portions including a first conductor portion formed on the first principal surface and a second conductor portion formed on the second principal surface, and
wherein an end of the first conductor portion and an end of the second conductor portion overlapping with respect to the second direction are connected via a via conductor penetrating the substrate.

3. The inductor according to claim 1, further comprising an insulator overlapping the first internal conductor via the substrate.

4. The inductor according to claim 1, further comprising a second internal conductor, wherein the second internal conductor at least partially overlaps the first internal conductor via the substrate and is insulated from the first internal conductor.

5. The inductor according to claim 4, wherein the first internal conductor has a plurality of conductor portions including a first conductor portion formed on the first principal surface and a second conductor portion formed on the second principal surface,
wherein an end of the first conductor portion and an end of the second conductor portion overlapping with respect to the second direction are connected via a via conductor penetrating the substrate, and
wherein the second internal conductor includes at least one of a third conductor portion partially overlapping the second conductor portion of the first internal conductor via the substrate and is separated from the first conductor portion of the first internal conductor on the first principal surface, and a fourth conductor portion partially overlapping the first conductor portion of the first internal conductor via the substrate and is separated from the second conductor portion of the first internal conductor on the second principal surface.

6. The inductor according to claim 1, wherein, when viewed from the second direction, the first internal conductor is line-symmetrical with respect to a reference line extending along the first direction.

7. The inductor according to claim 1, wherein, when viewed from the second direction, a ratio of an area where the substrate exists to an area of the element body is 0.55 or less.

8. The inductor according to claim 1, wherein the element body has a mounting surface, and at least a part of the external electrodes is provided on the mounting surface, and
wherein the inductor further comprising a pair of connection conductors extending along the second direction within the element body and connect each of both ends of the first internal conductor to the external electrodes of a portion provided on the mounting surface.
